(19) United States
(12) Patent Application Publication
(10) Pub. No.: US 2013/0064708 A1
(43) Pub. Date: Mar. 14, 2013

(54) METHOD FOR PRODUCING CEMENTED CARBIDE PRODUCTS

(71) Applicants: Regina Lundell, Norberg (SE); Per Jonson, Fors (SE); Mattias Puide, Vasteras (SE)

(72) Inventors: Regina Lundell, Norberg (SE); Per Jonson, Fors (SE); Mattias Puide, Vasteras (SE)

(73) Assignee: SECO TOOLS AB, Fagersta (SE)

(21) Appl. No.: 13/636,187

(22) PCT Filed: Apr. 20, 2010
(86) PCT No.: PCT/SE11/50483

§ 371 Date: Nov. 30, 2012

(30) Foreign Application Priority Data
Apr. 20, 2010 (SE) 1050388-6

(51) Int. Cl. C08L 23/20; B29C 67/02; B22F 3/02

(52) U.S. Cl. 419/65; 524/579; 264/109

(57) ABSTRACT

A method for injection molding or extrusion of cemented carbide or cermet parts uses a binder system, including 20-70 wt-% olefinic polymer, 30-80 wt-% wax. The olefinic polymer is a co-polymer of polyethylene and poly(alpha-olefin). By using such a binder system, a tougher material behavior of the green body and a lower temperature during the injection molding or extrusion is achieved.

The present invention relates to a method for the production of tungsten carbide based hard metal tools or components using the powder injection moulding method.

Hard metals based on tungsten carbide are composites consisting of small (μm-scale) grains of at least one hard phase in a binder phase. These materials always contain the hard phase tungsten carbide (WC). In addition, other metal carbides with the general composition (Ti,Nb,Ta,W)C may also be included, as well as metal carbonitrides, e.g., Ti(C,N). The binder phase usually consists of cobalt (Co). Other binder phase compositions may also be used, e.g., combinations of Co, Ni, and Fe, or Ni and Fe.

Industrial production of tungsten carbide based hard metals often includes blending of given proportions of powders of raw materials and additives in the wet state using a milling liquid. This liquid is often an alcohol, e.g. ethanol or water, or a combination thereof. The mixture is then milled into homogeneous slurry. The wet milling operation is made with the purpose of deagglomeration and mixing the raw materials intimately. Individual raw material grains are also disintegrated to some extent. The obtained slurry is then dried and granulated, e.g. by means of a spray dryer. The granulate thus obtained may then be used in uniaxial pressing of green bodies or for extrusion or injection moulding.

Injection moulding is common in the plastics industry, where material containing thermoplastics or thermosetting polymers are heated and forced into a mould with the desired shape. The method is often referred to as Powder Injection Moulding (PIM) when used in powder technology. The method is preferably used for parts with complex geometry.

In powder injection moulding of tungsten carbide based hard metal parts, four consecutive steps are applied:

1. Mixing of the granulated cemented carbide powder with a binder system. The binder system acts as a carrier for the powder and constitutes 25-60 volume % of the resulting material, often referred to as the feedstock. The exact concentration is dependent on the desired process properties during moulding. The mixing is made by adding the constituents into a mixer heated to a temperature above the melting temperature of the organic binders. The resulting feedstock is obtained as pellets of approximate size 4×4 mm.

2. Injection moulding is performed using the mixed feedstock. The material is heated to a temperature where the organic constituents are molten and the feedstock is viscous and thereby processable with a common injection moulding machine. The viscous feedstock is then forced into a cavity with the desired shape. The thus obtained part is solidified by cooling or curing and then removed from the cavity.

3. Removing the binder from the obtained part. The removal can be obtained by extraction of the parts in a suitable solvent and/or by heating in a furnace with a suitable atmosphere. This step is often referred to as the debinding step.

4. Sintering of the parts. Common sintering procedures for cemented carbides are applied.

Extrusion of the feedstock comprises steps 1, 3 and 4 above. Instead of forcing the feedstock into a cavity of the desired shape, the feedstock is continuously forced through a die with the desired cross section.

A common binder system comprises two major organic materials and a few process aid chemicals. The process aid chemicals can be surfactants, plasticizers, i.e. rheology controlling agents, and process aid chemicals for the formation of granules during spray drying. The two major organic materials have a common function of working as a vehicle for the powder particles during injection moulding. When the green bodies have been injection moulded, they have different functions. One of the organic materials serves as a “backbone” holding the part together until it can be sintered. Usually, this “backbone” is a polymer. The other organic material works as the removable part. When the removable part has been removed, an open porosity is left in the part. This porosity is used for the escape of the pyrolysis gases during the following binder removal by thermal pyrolysis in a furnace. These organic materials have to be chemically compatible, but must not be miscible. A part of the binder is removed before thermal by extraction with a nonpolar solvent, e.g. carbondioxide at supercritical physical conditions, n-hexane or any other aliphatic alkane.

A common way to formulate a binder system according to the description above is to use polypropylene or polyethylene or a combination thereof or a copolymer of polyethylene and polypropylene as the backbone polymer and an aliphatic hydrocarbon wax, e.g. a microcrystalline wax, a Fischer-Tropsch wax or a paraffin wax or a combination thereof as the removable organic material. The removal of the wax can be performed with extraction with a nonpolar solvent, e.g. carbondioxide at super-critical physical conditions, n-hexane or any other aliphatic alkane.

When using polypropylene or polyethylene or a combination thereof or a copolymer of polyethylene and polypropylene as the backbone polymer a feedstock for production of cemented carbide, the solidified feedstock usually becomes brittle. This brittleness can cause the parts to crack during extraction, where the expansion of the wax during melting causes stresses in the part. Some of the backbone polymers described above may even cause the part to crack when stored in room temperature. Another drawback with the brittle material is that the parts may be damaged during handling of the parts. Further, the use of the mentioned polymers as the backbone in the feedstock formulation gives a feedstock with a need for a relatively high processing temperature. High temperatures may cause the processing aid chemicals to evaporate, forming blisters in the material. High processing temperatures may also cause sink marks and shrinkage blisters in the material.

It is an object of the present invention to provide a feedstock with a lower processing temperature and without brittle material characteristics.

It has now surprisingly been found that by using copolymers of polyethylene and poly(alpha-olefin) as the backbone polymer, a feedstock showing both chemical compatibility and non-miscibility between the backbone polymer and the removable organic material can be produced without experiencing the problems mentioned.

The present invention comprises the following steps:

1) Wet milling of the raw materials in water or alcohol or a combination thereof, preferably 80 wt-% ethanol and 20 wt-% water, together with 0.1-1.2 wt-%, preferably 0.25-0.55 wt-% carboxylic acid, preferably stearic acid, as a granulating agent for the subsequent drying. More carboxylic acid is required the smaller the grain size of the hard constituents.

2) Drying of the slurry formed during the above mentioned wet milling process step.

3) Mixing the dried powder by kneading with a binder system, consisting of 20-70 wt-% co-polymer of polyethylene and poly(alpha-olefin), preferably poly(ethylene-co-(alpha-octene)) with a density in the range of 0.860-0.915 g/ml, more preferably in the range of 0.880-0.915 g/ml, most preferably in the range of 0.890-0.915 g/ml, 30-80 wt-% waxes and, preferably, 2.5-10 wt-% petroleum jelly. The mixing is performed in a batch mixer or twin screw extruder, heated to 50-200° C. that forms pellets with a size of approximately 4×4 mm.

4) Injection moulding of the feedstock in a conventional injection moulding machine. Alternatively, the feedstock is extruded in a single screw, twin screw or plunge type extruder. The material is heated to 100-240° C., preferably 100-150° C., and then, in the case of injection moulding, forced into a cavity with the desired shape. In extrusion, the material is forced through a die with the desired cross section. The part obtained in injection moulding is cooled and then removed from the cavity. The extrudates are cut in pieces of desired length.

5) Debinding the obtained part. The debinding is performed in two steps.

5a) By extraction of the removable organic material, preferably in a nonpolar solvent, at 31-70° C., preferably at 45-60° C., e.g. carbondioxide at supercritical physical conditions, n-hexane or any other aliphatic alkane, preferably carbon dioxide at supercritical physical conditions. It is within the purview of the skilled artisan to determine by experiments the conditions necessary to avoid the formation of cracks and other defects according to this specification.

5b) By heating in a furnace, preferably in a flowing gaseous medium atmosphere, at 2 mbar to atmospheric pressure up to 450° C. It is within the purview of the skilled artisan to determine by experiments the conditions necessary to avoid the formation of cracks and other defects according to this specification.

6) Presintering of the part in the debinding furnace in vacuum at 900-1250° C., preferably at about 1200° C.

7) Sintering of the parts using conventional sintering technique.

The invention also relates to a binder system for injection moulding or extrusion of cemented carbide or cermet parts, comprising 20-70 wt-% olefinic polymer and 30-80 wt-% wax, where said olefinic polymer is a co-polymer of polyethylene and poly(alpha-olefin).

The invention can be used for all compositions of cemented carbide and all WC grain sizes commonly used as well as for titanium carbonitride based materials.

### EXAMPLE 1

A WC-13 wt-% Co submicron cemented carbide powder was made by wet milling 780 g Co-powder (0MG extra fine), 38.66 g Cr3C2 (H C Starck), 5161 g WC (H C Starck DS80), 20.44 g W metal powder, 16 g Fisher-Tropsch wax (Sasol H1) and 22 g stearic acid in 1,6 1 milling liquid consisting of ethanol and water (80:20 by weight) for 40 h. The stearic acid is added in this stage of the process to work as a granule forming agent, when spray drying the slurry. The resulting slurry was spray dried to a granulated powder.

### EXAMPLE 2 (COMPARATIVE)

The powder made in Example 1 was mixed by kneading 2500 g powder from Example 1 with 50.97 g Polypropylene-polyethylene copolymer (RD360 MO, Borealis) and 45.87 g Paraffin wax (Sasol Wax) and 5.06 g petroleum jelly (Merkur VARA AB) in a Z-blade kneader mixer (Werner & Pfleiderer LUK 1,0).

### EXAMPLE 3 (INVENTION)

The powder made in Example 1 was mixed by kneading 2500 g powder from Example 1 with 50.97 g poly(ethylene-co-(alpha-octene)) with a density of about 0.895 g/ml (Engage 8440, Dow Plastics) and 45.87 g Paraffin wax (Sasol Wax) and 5.06 g petroleum jelly (Merkur VARA AB) in a Z-blade kneader mixer (Werner & Pfleiderer LUK 1,0).

### EXAMPLE 4 (COMPARATIVE)

The feedstock made in example 2 was fed into an injection moulding machine (Battenfeld HM 60/130/22). The machine was used for the injection moulding of a Seco Tools Minimaster 10 mm endmill green body. The material temperature needed for the injection moulding was 160° C. The parts were cut for inspection and a few blisters were detected in some of the parts.

### EXAMPLE 5 (INVENTION)

The feedstock made in example 3 was fed into an injection moulding machine (Battenfeld HM 60/130/22). The machine was used for the injection moulding of a Seco Tools Minimaster 10 mm endmill green body.

The material temperature needed for the injection moulding was 125° C. The parts were cut for inspection and no blisters were detected.

### EXAMPLE 6 (COMPARATIVE)

The parts from example 4 were debound by extraction in carbon dioxide at supercritical physical conditions, i.e. at 35 MPa and 58° C. for 20 hours. After the extraction the parts were inspected. The parts showed surface cracks visible to the naked eye.

### EXAMPLE 7 (INVENTION)

The parts from example 5 were debound by extraction in carbon dioxide at supercritical physical conditions, i.e. at 35 MPa and 58° C. for 20 hours. After the extraction the parts were inspected. The parts showed no cracks visible to the naked eye and no cracks when inspected in 50× magnification.

1. Method for injection moulding or extrusion of cemented carbide or cermet parts, comprising the following steps:
wet milling of raw materials in water or alcohol or a combination thereof,
drying of the slurry formed during the wet milling process step,
mixing the dried powder by kneading with a binder system, consisting of 20-70 wt-% co-polymer of polyethylene and poly(alpha-olefin), and 30-80 wt-% waxes,
injection moulding of the feedstock in an injection moulding machine or extruding the feedstock in a single screw, twin screw or plunge type extruder, and
debinding the obtained part.

2. Method according to claim 1, characterised in that said copolymer of polyethylene and poly(alpha-olefin) is a poly(ethylene-co-(alpha-octene)).

3. Method according to claim 2, characterised in that said poly(ethylene-co-(alpha-octene)) has a density in the range of 0.860-0.915 g/ml.

4. Method according to claim 3, characterised in that said poly(ethylene-co-(alpha-octene)) has a density in the range of 0.880-0.915 g/ml.

5. Method according to claim 4, characterised in that said poly(ethylene-co-(alpha-octene)) has a density in the range of 0.890-0.915 g/ml.

6. A binder system for injection moulding or extrusion of cemented carbide or cermet parts, comprising 20-70 wt-% olefinic polymer, 30-80 wt-% wax, characterised in that said olefinic polymer is a co-polymer of polyethylene and poly(alpha-olefin).

7. A binder system according to claim 6, characterised in that said copolymer of polyethylene and poly(alpha-olefin) is a poly(ethylene-co-(alpha-octene)).

8. A binder system according to claim 7, characterised in that said poly(ethylene-co-(alpha-octene)) has a density in the range of 0.860-0.915 g/ml.

9. A binder system according to claim 8, characterised in that said poly(ethylene-co-(alpha-octene)) has a density in the range of 0.880-0.915 g/ml.

10. A binder system according to claim 9, characterised in that said poly(ethylene-co-(alpha-octene)) has a density in the range of 0.890-0.915 g/ml.
